(19) United States
(12) Patent Application Publication
(10) Pub. No.: US 2023/0200297 A1
(43) Pub. Date: Jun. 29, 2023

(54) Portable work apparatus

(71) Applicant: Andreas Stihl AG & Co. KG, Waiblingen (DE)

(72) Inventors: Henrik Pahlitzsch, Munich (DE); Marcel Kaltenberg, Aachen (DE); Dirk Queck, Neustadt (DE); Mathias Winter, Leipzig (DE); Robin Stroda, Apelen (DE); Matthias Nagl, Berlin (DE); Alexander Kraft, Halle (DE); Simon Barth, Salzwedel (DE); Jonas Hefti, Stuttgart (DE)

(21) Appl. No.: 18/145,653

(22) Filed: Dec. 22, 2022

(30) Foreign Application Priority Data
Dec. 23, 2021 (EP) 21217581.4

(51) Int. Cl. A01D 34/82; A01D 75/18; A01D 34/90; A01D 34/68

(52) U.S. Cl. CPC A01D 34/828; A01D 34/68; A01D 34/90; A01D 75/185

(57) ABSTRACT

The disclosure relates to a portable work apparatus. The work apparatus includes a spacer which is arranged on the front housing and has a contact region. The contact region has a maximum distance, as measured radially, with respect to the rotational axis of the output shaft, the distance being greater than the cutting radius of the cutting tool in a first, non-deformed state of the spacer. The spacer is elastically deformable. The spacer is elastically deformed in a second state in such a manner that the maximum distance of the contact region is at most the same size as the cutting radius, and the spacer is arranged completely outside the cutting plane of the cutting tool.

### CROSS-REFERENCE TO RELATED APPLICATIONS

This application claims priority of European patent application no. 21217581.4, filed Dec. 23, 2021, the entire content of which is incorporated herein by reference.

### BACKGROUND

Portable work apparatuses, such as lawn trimmers, motor scythes and brush cutters, serve for mowing grass or undergrowth or the like. For this purpose, a mower head with a tool is driven in rotation about a rotational axis, as a result of which the material to be cut is cut in contact with the tool. In addition to cutting threads, it is also possible to use cutting knives, cutting blades, saw blades or the like as tools. In order to facilitate mowing around obstacles, a spacer can be provided on the work apparatus. Known spacers are configured in such a manner that they ensure a distance between mower head and obstacle upon contact with an obstacle, for example a curb, and therefore the obstacle cannot be contacted by the cutting tool.

Spacers of this type maintain a safety distance between obstacle and cutting tool, as a result of which neither the cutting tool nor the obstacle is damaged. However, it is disadvantageous that the region over which the safety distance extends is not accessible to the cutting tool and therefore also cannot be mowed. Leaving material to be cut unprocessed is intended, however, to be specifically avoided by the use of the abovementioned work apparatuses. In particular in the case of tools which are subject to increased wear, for example cutting threads, as the cutting thread becomes increasingly worn, the region which cannot be mowed by the cutting tool also increases. It is disadvantageous that the user frequently has to readjust the cutting thread in order to minimize the region not accessible to the cutting tool.

### SUMMARY

It is an object of the disclosure to provide a portable work apparatus in such a manner that, in addition to a high degree of accessibility, sufficient protection for the cutting tool is also provided.

The object is, for example, achieved by a portable work apparatus having the features of: a front housing; an output shaft protruding from the front housing; a main body connected to the output shaft; a cutting tool arranged on the main body; a drive motor; the main body together with the cutting tool being drivable via the drive motor so as to rotate about a rotational axis of the output shaft; the cutting tool defining a cutting circle with a cutting radius rotating in a cutting plane about the rotational axis; a spacer arranged on the front housing and having a contact region; the spacer being elastically deformable; the contact region having a maximum distance, measured radially, to the rotational axis of the output shaft; the maximum distance being greater than the cutting radius of the cutting tool in a first, non-deformed state of the spacer; and, the spacer being elastically deformed in a second state such that the maximum distance is at most a same size as the cutting radius, and the spacer being arranged completely outside the cutting plane of the cutting tool.

The portable work apparatus according to the disclosure includes a front housing, an output shaft protruding from the front housing, and a main body connected to the output shaft. Furthermore, the portable work apparatus includes a cutting tool which is arranged on the main body. The main body is drivable together with the cutting tool via a drive motor so as to rotate about a rotational axis of the output shaft. The cutting tool has a cutting circle with a cutting radius rotating in a cutting plane about the rotational axis. The cutting plane is spanned by the rotating cutting tool. Furthermore, the portable work apparatus includes a spacer arranged on the housing and having a contact region. The contact region has a maximum distance, as measured radially with respect to the rotational axis of the output shaft, the distance being greater than the cutting radius of the cutting tool in a first, non-deformed state of the spacer. The spacer is elastically deformable. The spacer is elastically deformed in a second state in such a manner that the maximum distance of the contact region is at most the same size as the cutting radius, and that the spacer is arranged completely outside the cutting plane of the cutting tool.

In its first state, the spacer of the portable work apparatus according to the disclosure makes it possible to maintain a safety distance between the cutting tool and the obstacle which is to be mowed around, for example, by an operator of the work apparatus. Should the operator wish to bridge the safety distance, the operator can press the work apparatus with the spacer against the obstacle in such a manner that the spacer is elastically deformed and the cutting tool reaches as far as the obstacle. Therefore, in the second state of the spacer, all of the material to be cut is accessible to the cutting tool and can be cut by the latter. If the spacer is elastically deformed, contact between the cutting tool and the obstacle is not ruled out. Such a contact between cutting tool and obstacle is consciously caused by the user since the elastic deformation of the spacer has to be initiated specifically by the user against a noticeable mechanical resistance. The user can therefore decide based on the application whether the user contacts the obstacle to be mowed around with the fitted cutting tool or wishes to maintain a distance therefrom. If the user subsequently does not exert any pressure on the spacer, the latter molds back into its starting state, namely into the first, non-deformed state. If the cutting tool is already worn, the reduced range of the cutting tool can be compensated for by the elastic deformation of the spacer.

A maximum elastic deformation of the spacer preferably corresponds to at least 5% of the maximum distance of the contact region from the rotational axis. An increased degree of accessibility of the cutting tool can thereby be ensured.

It can preferably be provided that the spacer includes a carrier and an end piece fastened to the carrier, with the contact region of the spacer being formed on the end piece. Preferably, the carrier is rigid and the end piece is elastically deformable. The carrier and the end piece are advantageously composed of different materials. The elastic deformability of the spacer is thereby adjustable easily in a targeted way. It is advantageously provided that the end piece is composed of an elastomer. The end piece and therefore also the spacer are thereby elastically deformable. In addition, the formation of the end piece from an elastomer enables gentle contact with possible obstacles. Alternatively, the elastic deformability can be produced not by the selection of material, but rather by the geometry of the end piece. The geometry of the end piece should be configured here in such a manner that the end piece has a degree of flexibility in the loading direction. Of course, in an advantageous embodiment, the spacer, in particular the end piece, can be provided with an elastically deformable material, for example an elastomer, and can at the same time have a geometrical structure which promotes a corresponding degree of flexibility.

The end piece is preferably exchangeable on the carrier. During the operation of the portable work apparatus, after a few operating hours, the end piece can become worn or even damaged by the frequent contact with obstacles. In such cases, it saves on expense to be able merely to exchange the end piece without having to change the carrier or the entire spacer. The end piece is preferably held on the carrier via a latching connection. The exchange of the end piece on the carrier can therefore be undertaken in a simple way. The exchangeability of the end piece also enables the use of different end pieces. These may differ, for example, in their shape and their material. Accordingly, the end pieces may also have different degrees of flexibility. This enables the use of a specific end piece tailored to the corresponding cutting tool.

It is advantageously provided that the end piece is formed from a ring and an extension, which is arranged thereon, for fastening to the carrier. The ring can be compressed. If the extension is correspondingly elastic, it can likewise also be deformed during the deformation of the ring. In this embodiment, the elastic deformability of the end piece is promoted by the geometrical structure. The wall thickness of the ring preferably decreases as the radial distance from the rotational axis of the output shaft increases. The smallest wall thickness is therefore preferably provided at the contact zone of the spacer. In this embodiment, there is a particularly high degree of flexibility in the contact zone of the spacer, as a result of which the operator can press in the end piece of the spacer in a controlled way. The controlled pressing in is of particular importance since an inadvertent overpressing of the spacer and in consequence increased wear of the cutting tool can therefore be avoided.

A plurality of spacers are preferably provided on the front housing. The spacers are formed in particular in the manner of fingers. It is preferably provided that the spacers extend in a longitudinal direction, each spacer being arranged radially with respect to the rotational axis of the output shaft. The finger-like configuration and the radial arrangement of the spacers promote the supply of the material to be mowed. If the mower head and the spacer are guided over the ground, the material to be cut is pushed between the fingers. Pressing down of the material to be cut can be avoided. In an alternative embodiment, it can also be provided that the end piece is in the form of a bracket.

Preferably, a receiving arrangement is provided on the front housing, the spacer being held releasably on the receiving arrangement. The spacer is preferably held exchangeably on the receiving arrangement. As a result, a specific spacer can be provided depending on the application. The spacers can differ, for example, in their shape and in their material. Spacers with different degrees of flexibility, for example for different cutting tools, can thus also be provided. It can also be expedient to provide spacers with different geometries which are matched, for example, to the material to be cut.

The spacer is preferably held pivotably on the front housing. The spacer can therefore be pivoted by the user into an operating position or into a not in service position depending on requirements.

It can advantageously be provided that the end piece is held on the carrier at a connecting section, the connecting section being at a distance, as measured radially with respect to the rotational axis of the output shaft, from the rotational axis, the distance being at least 33%, preferably at least 50%, in particular at least 66% of the maximum distance of the contact region from the rotational axis.

### BRIEF DESCRIPTION OF DRAWINGS

The invention will now be described with reference to the drawings wherein:

FIG. 1 shows a schematic illustration of a brush cutter held by an operator;

FIG. 2 shows a perspective illustration of a front housing of a brush cutter with a spacer;

FIG. 3 shows a top view of the front housing according to FIG. 2;

FIG. 4 shows a side view of the front housing according to FIG. 2;

FIG. 5 shows a side view of the front housing according to FIG. 2 without a spacer;

FIG. 6 shows a perspective illustration of a spacer according to FIG. 2;

FIG. 7 shows a front view of the front housing according to FIG. 2 with a spacer pivoted into a not in service position;

FIG. 8 shows a perspective side view of an end piece of the spacer according to FIG. 2;

FIG. 9 shows a view from below of the end piece according to FIG. 8;

FIG. 10 shows a schematic perspective illustration of part of a carrier of a spacer;

FIG. 11 shows a schematic top view of an alternative spacer according to the disclosure with a bracket;

FIG. 12 shows a schematic top view of an alternative spacer according to the disclosure with a bracket and extended carrier;

FIG. 13 shows a schematic top view of an alternative spacer according to the disclosure with a spring element;

FIG. 14 shows a perspective view of a further embodiment according to the disclosure of the spacer;

FIG. 15 shows a top view of the spacer according to FIG. 14 in a non-deformed state,

FIG. 16 shows a view from below of the spacer according to FIG. 14 in a non-deformed state,

FIG. 17 shows a side view of the spacer according to FIG. 14; and,

FIG. 18 shows a top view of the spacer according to FIG. 14 in a deformed state.

### DETAILED DESCRIPTION

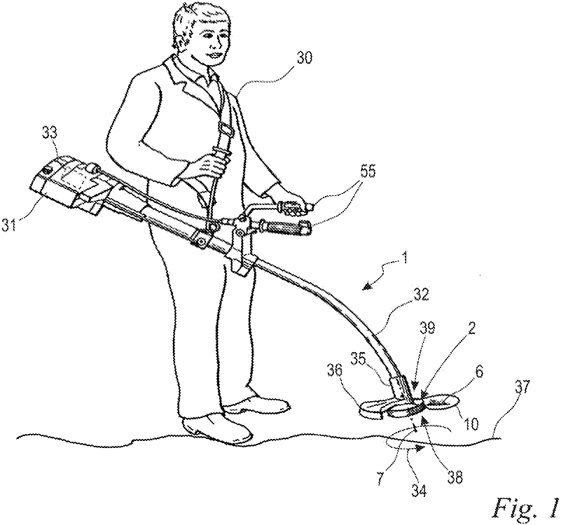

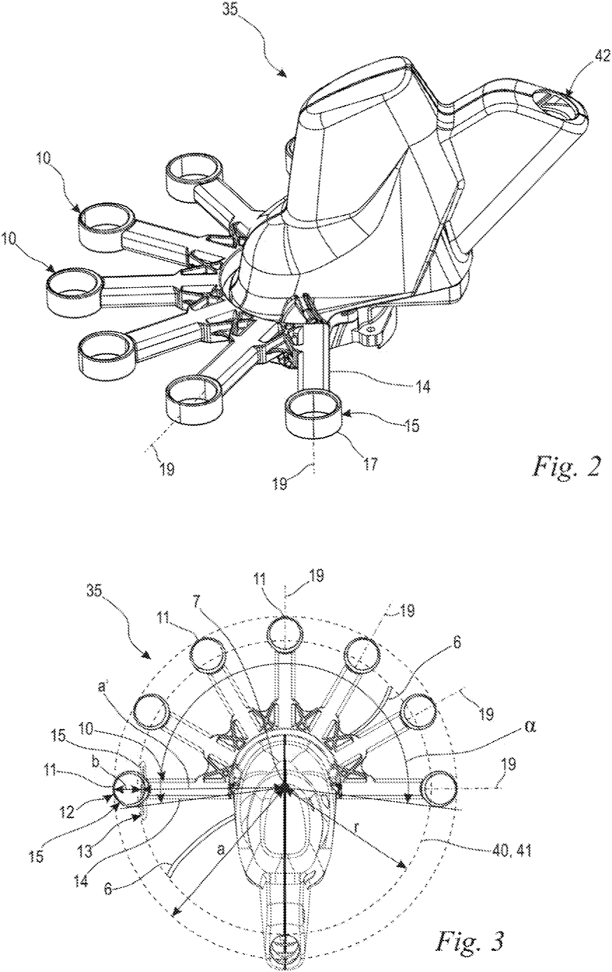

FIG. 1 shows, in a schematic illustration, a portable work apparatus - referred to below as work apparatus. The term “portable work apparatus” should be understood as meaning a work apparatus which is configured in such a manner that it can be carried by the operator in operation and guided by hand. The work apparatus is configured here as a brush cutter. The work apparatus 1 is held by an operator 30. The work apparatus 1 has a rear end with a rear housing 31 and a front end, from which an output shaft 3 protrudes. A shaft 32 connects the rear end and the front end. Handles 55 for guiding the work apparatus 1 are arranged in the shaft 32. A mower head 2 is connected to the front end of the work apparatus 1. The mower head 2 is fastened to the output shaft 3 and is driven in rotation about a rotational axis 7 in an operational rotating direction 34 by a drive motor 33, merely indicated schematically. The drive motor 33 is arranged in the rear housing 31, with an output shaft running in the shaft 32. Provision may be made for the output shaft to be directly connected in the shaft to the output shaft 3 for the mower head 2; accordingly, a transmission is not connected in between. In an alternative embodiment, not illustrated, the drive motor 33, which is in particular an electric motor, can also be arranged on a front housing (FIG. 2) which is arranged at the front end. A transmission of the mower head 2 is advantageously also located in the front housing 35. The mower head 2 is covered on the side facing the operator 30 during operation by a protective cover 36. The mower head 2 has at least one cutting tool 6 which, in the embodiment, serves as a cutting thread for cutting material to be cut, such as grass, undergrowth or the like. A bottom side 38 facing the ground 37 during operation is formed on the mower head 2, the bottom side being arranged on that side of the mower head 2 which faces away from the shaft 32. The top side 39 of the mower head 2 is formed on that side of the mower head 2 which faces the shaft 32. The protective clothing which has to be worn by the operator 30 for operation of the brush cutter 1 is not shown in the simplified illustration.

FIG. 2 shows the front housing 35 of the work apparatus 1 according to the disclosure, with the drive motor 33, not illustrated specifically, being provided in the front housing 35 in the embodiment shown. The front housing 35 includes a receiver 42 which serves for attachment of the shaft 32. The receiver 42 is in the form of an opening in the front housing 35. In the mounted state of the work apparatus 1, the shaft 32 protrudes into the opening, with the front housing 35 being clamped, screwed or held in a similar manner on the shaft 32. The front housing 35 is preferably formed from two housing halves.

As shown in FIG. 2, at least one spacer 10 is provided on the front housing 35. In the embodiment, seven spacers 10 are arranged on the front housing 35. It may also be expedient to provide a different number of spacers 10. The spacer 10 includes a carrier 14 and an end piece 15. The end piece 15 is held on the front housing 35 via the carrier 14. The end piece 15 is held on the carrier 14 via a connecting section 59. A contact region 11 is provided on the spacer 10. The contact region 11 is the region of the spacer 10 that is provided for contacting obstacles during the operation of the work apparatus 1. The contact region 11 is provided on the end piece 15 of the spacer 10.

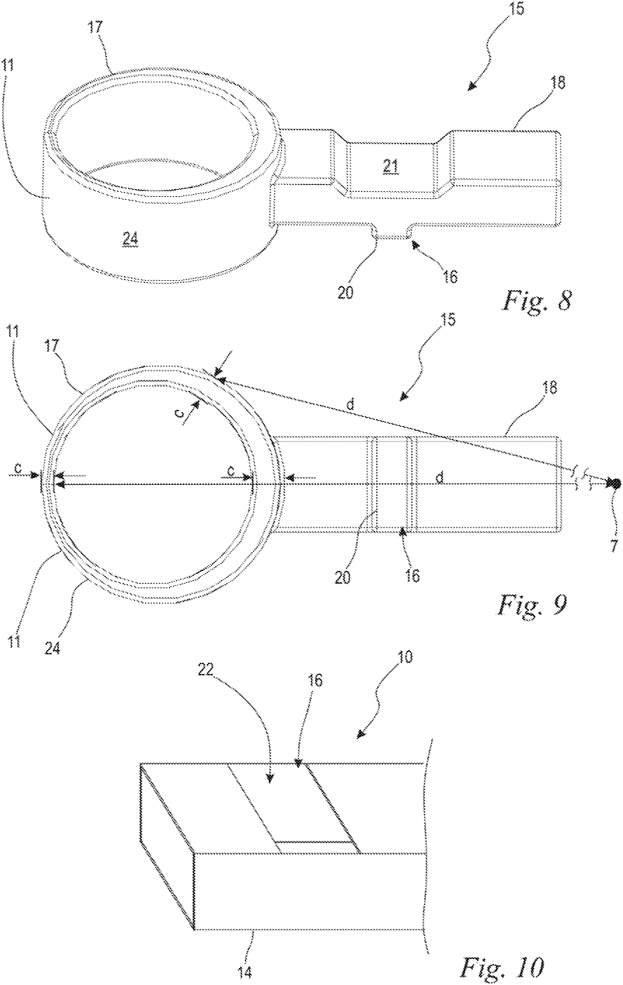

As shown in FIGS. 8 and 9, the end piece 15 is formed from an extension 18 and a ring 17 adjoining the extension 18. The extension 18 and the ring 17 are preferably formed integrally. The extension 18 has a substantially rectangular profile. A protrusion 20 is formed on one side of the extension 18 in the embodiment. A depression 21 is formed on that side of the extension 18 which is opposite the protrusion 20. Via the depression 21 in the end piece 15, the end piece 21 is elastically deformable in the region of the protrusion 20 in the direction of the depression. For the purpose of fastening the end piece 15 of the spacer 10, it has to be pushed into the carrier 14 at a free end 23 of the carrier 14. The carrier 14 corresponds at its free end 23 to a hollow profile for receiving the end piece 15. When the end piece 15 is pushed into the carrier 14, the protrusion 20 of the end piece 15 is pressed in the direction of the depression 21 of the end piece 15. In this state, the end piece 15 is prestressed in the region of the protrusion. The end piece 15 has to be pushed into the carrier 14 here until the protrusion 20 of the end piece latches into a latch opening 22 (FIG. 10) of the carrier 14. In the latched-in state, the end piece is relieved of load again. To release the end piece 15 from the carrier 14, the protrusion 20 has to be pushed in and the end piece 15 pulled out of the carrier 14. The end piece 15 is consequently held on the carrier 14 via a latching connection 16. The latching connection 16 is releasable. The latching connection 16 is formed by the protrusion 20 of the end piece 15 and by the latching opening 22 of the carrier 14. A simple exchange of the end piece 15 is therefore made possible.

As FIGS. 8 and 9 show, the ring 17 is approximately circular. In an alternative embodiment of the work apparatus 1, it may be expedient to provide a differently shaped contour instead of a ring 17. The contour may be closed, but open contours, for example a C contour, are also conceivable. The ring 17 has a wall thickness c. The wall thickness c can differ along the ring circumference 24. As shown in FIG. 9, the wall thickness c of the ring 17 decreases as the radial distance d from the rotational axis 7 of the output shaft 3 increases. In the embodiment, the wall thickness c of the ring 17 decreases continuously. By contrast, in an alternative embodiment, it may also be expedient to provide an abrupt change in the wall thickness c. As FIGS. 8 and 9 show, the contact region 11 is provided on the ring 17. If the work apparatus 1 makes contact with a stationary obstacle via the contact region 11 of the spacer 10, the ring 17 is elastically deformed. The minimum wall thickness c of the ring 17 at the outermost region of the ring 17 with respect to the rotational axis 7 means that the force which has to be applied initially and is necessary for the purpose of deforming the end piece 15 is very small. Should the operator 30 of the work apparatus 1 wish to further deform the end piece 15 of the spacer 10, the operator has to apply an ever-increasing force. As the wall thickness c of the ring 17 increases, the deformation resistance which has to be overcome by the operator 30 therefore also increases. In this way, relatively large unintended deformations of the spacer 10 and therefore also undesirable damage due to a collision with the obstacle at the cutting tool 6 can be avoided.

In the embodiment, the end piece 15 is formed from an elastically deformable material, in particular from an elastomer. By contrast, the carrier 14 is formed from a rigid material, in particular a thermosetting plastic or a thermoplastic. Alternatively, the carrier 14 may also be formed from a metal material. In a particularly preferred embodiment of the work apparatus 1, the material of the end piece 15 has a lower modulus of elasticity than the material of the carrier 14. In a further embodiment of the work apparatus 1, it can also be provided, by contrast, that the end piece 15 itself is formed from a plurality of materials, with at least one material having a lower modulus of elasticity than the carrier 14. When configuring the end piece 15 and the carrier 14, it is essential, inter alia, for the end piece 15, in contrast to the carrier 14, to be elastically deformable. The elastic deformability can be formed by the geometry of the end piece 15 and/or by the suitable selection of the material.

As FIGS. 2, 3, 4 and 6 show, a plurality of spacers 10, seven in the present embodiment, are provided on the front housing 35. The spacers 10 extend radially outward in the manner of fingers from the rotational axis 7 of the output shaft 3. The spacers 10 each extend in a longitudinal direction 19, the spacers 10 being arranged in relation to the front housing 35 in such a manner that the longitudinal direction 19 of each spacer 10 is preferably oriented approximately radially with respect to the rotational axis 7 of the output shaft 3. As shown in FIG. 3, the spacers 10 are arranged at identical angular distances from one another. The spacers 10 form an active zone 25 in which the cutting tool of the work apparatus 1 can be kept at a distance from obstacles via the spacers 10. In the present embodiment, this active zone extends around the rotational axis 7 over all of the spacers 10. The active zone 25 extends here with respect to the rotational axis 7 of the output shaft 3 by an angular section α, the angular section α being at least 90°, in particular at least 120°, preferably at least 160°.

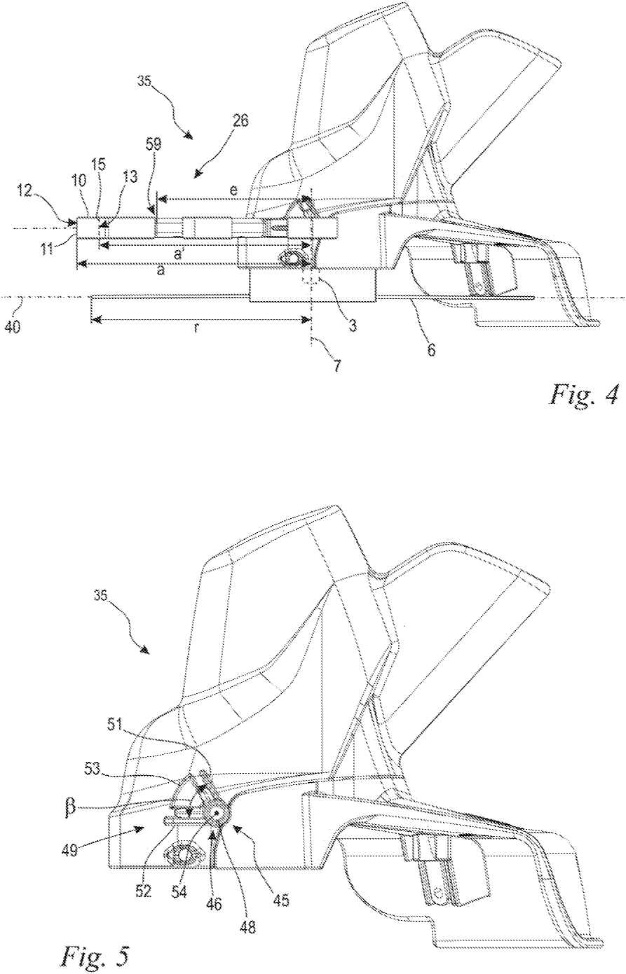

As FIGS. 3 and 4 show, the cutting tool 6 spans a cutting plane 40 when rotated about the rotational axis 7 of the output shaft 3. Accordingly, the cutting tool 6 rotates in the cutting plane 40. In the embodiment shown, the cutting tool 6 includes two free ends 43 which, when they rotate about the rotational axis 7, form a cutting circle 41 which lies in the cutting plane 40. The cutting circle 41 has a cutting radius r. The contact region 11 of a spacer 10, in its first, non-deformed state 12, has a maximum distance a from the rotational axis 7 of the output shaft 3. In this first, non-deformed state 12, the spacer 10 is not in contact with an obstacle. The maximum distance a in the first, non-deformed state 12 of the spacer 10 is greater than the cutting radius r of the cutting tool 6. If the spacer 10 is pressed in at its contact region 11, the spacer 10 is in its second, deformed state 13. The deformed end piece 15 is illustrated schematically by dashed lines in each of FIGS. 3 and 4. In this state, the maximum distance a′ of the elastically deformed spacer is at most the same size as the cutting radius r of the cutting tool 6. As a result, during mowing in the region of curbs, the spacer 10 can be deformed in such a manner that the cutting tool 6 makes contact with the obstacle or the curb and all of the material to be cut can be cut. Of course, the cutting tool 6 is subject to a certain amount of wear. If the cutting radius r is smaller than the maximum distance a′ of the elastically deformed spacer 10, the tool has to be readjusted in order to enable cutting radially outside the maximum distance a′ of the deformed spacer 10. The cutting radius r is preferably at least the same size as the maximum distance a′ of the elastically deformed spacer 10 and at most the same size as the maximum distance a of the elastically non-deformed spacer 10. In this region, as mentioned at the beginning, it is possible to compensate for the wear of the cutting tool 6 via the elastic deformation of the spacer without having to change or readjust the cutting tool 6. When the spacer 10 is elastically deformed, it is located completely outside the cutting plane 40 since otherwise the spacer 10 would collide with the cutting tool. As shown in FIG. 3, the spacer 10 has a maximum elastic deformation b, as measured radially with respect to the rotational axis 7. The maximum elastic deformation b of the spacer 10 corresponds to at least 5%, in particular at least 10%, preferably approximately 15% of the maximum distance a between contact region 11 and rotational axis 7 in a first, non-deformed state 12 of the spacer 10. The maximum elastic deformation b of the spacer 10 corresponds to at most 40%, in particular at most 25% of the maximum distance a between contact region 11 and rotational axis 7 in a first, non-deformed state 12 of the spacer 10. The connecting section 59 is at a distance e, as measured radially with respect to the rotational axis 7 of the output shaft 3, from the rotational axis 7. This distance e is at least 33%, preferably at least 50%, in particular at least 66% of the maximum distance a of the contact region 11 from the rotational axis 7. The carrier 15 preferably extends over a larger section, as measured radially with respect to the rotational axis 7, than the end piece 15.

As FIGS. 5 to 7 show, the spacer 10 is held pivotably on the front housing 35 of the work apparatus 1 via a receiving arrangement 45. The receiving arrangement 45 provides two positions, namely an operating position 26 and a not in service position 27, for the spacer 10. In the operating position 26, the spacer 10 is oriented in such a manner that the longitudinal direction 19 of the spacer 10 runs approximately parallel to the cutting plane 40. In the operating position 26 of the spacer 10, the maximum distance a in a first, non-deformed position 12 between the contact region 11 of the spacer 10 and the rotational axis 7 of the output shaft 3 is greater than the cutting radius r of the cutting tool 6. In the not in service position 27 of the spacer 10, the spacer 10 is pivoted in the direction from the bottom side 38 to the top side 39, as a result of which the maximum distance a in a first, non-deformed position 12 between the contact region 11 of the spacer 10 and the rotational axis 7 of the output shaft 3 is smaller than the cutting radius r of the cutting tool 6. Accordingly, the function of the spacer 10, namely of holding the cutting tool 6 at a distance from obstacles, is neutralized in its not in service position 27. The sole exceptions to this are the spacers 10, the longitudinal axes of which lie approximately on the pivot axis 54.

As FIGS. 5 to 7 show, the receiving arrangement 45 is formed from a bearing 46 and a latching mechanism 49. The bearing 46 is formed from a bearing pin 47, which is formed on the spacer 10 in the embodiment, and a bearing opening 48, which is formed on the front housing 35, for receiving the bearing pin 47. Of course, two bearings 46 are provided on opposite sides of the front housing 36, the two bearings 46 having a common pivot axis 54.

The latching mechanism 49 includes a latching element 50 which is in the form of a rib on the spacer 10. An upper stop element 51, a lower stop element 52 and a counter element 53 arranged between the two stop elements is arranged on the front housing 35. The counter element 53 is arranged spaced apart from the two stop elements 51, 52. The counter element 53 is in the form of a protrusion on the front housing 35. In the operating position 26 of the spacer 10, the latching element 50 is latched between the lower stop element 51 and the counter element 53. For the purpose of pivoting from the operating position 26 into the not in service position 27, the spacer 10 has to be pressed upward about the pivot axis 54 of the bearings 46. In the process, the resistance moment which arises from the contact between the latching element 50 of the spacer 10 and the counter element 53 of the front housing 35 has to be overcome. The spacer 10 has to pivot until the latching element 50 strikes against the upper stop element 51. The latching element 50 snaps into place here between the counter element 53 and the upper stop element 51 and is held in the not in service position 27. The latching mechanism 49 is preferably also formed on two opposite sides of the front housing 35. The upper stop element 51 and the lower stop element 52 have an angular distance β of preferably approximately 60° with respect to the pivot axis 54.

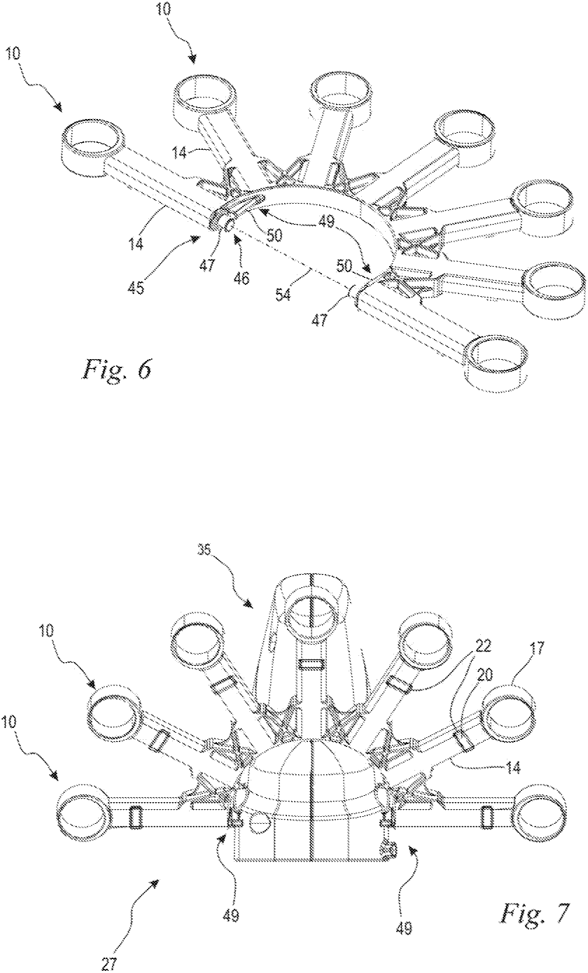

As in particular FIG. 6 shows, in the embodiment the carriers 14 and the spacer 10 are formed integrally.

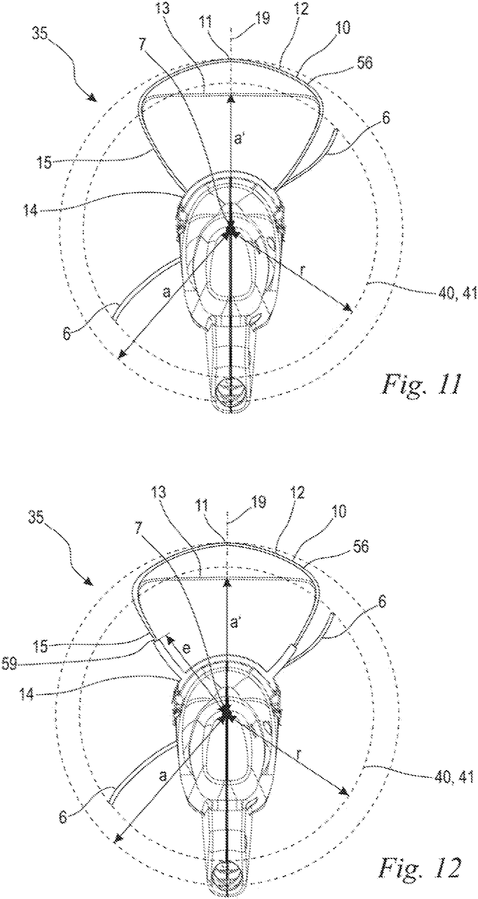

FIG. 11 shows a further embodiment according to the disclosure of a work apparatus 1 with a spacer 10. The work apparatus 1 includes just one single spacer 10 which likewise has a carrier 14 and an end piece 15. The end piece 15 is in the form of an elastically deformable bracket 56. The bracket 56 of the spacer 10 is formed from a deformable material. The spacer 10 shown in FIG. 11 has the same deformation properties as the above-described embodiments. The illustration of the bracket 56 by dashed lines shows the bracket in its second, deformed position 13 in which the maximum distance a′ is smaller than the cutting radius r of the cutting tool 6. In the first, non-deformed position 12 of the bracket 56, the maximum distance a is greater than the cutting radius r of the cutting tool. In a further alternative embodiment, it may be expedient to also configure the bracket 56 in a different form. It may also be expedient to configure the cross section of the bracket 56 differently for targeted adjustment of a resistance moment along the bracket 56. Furthermore, the angular section α about which the bracket 56 extends with respect to the rotational axis 7 of the output shaft 6 can also be adapted.

FIG. 12 shows a further embodiment according to the disclosure of a work apparatus 1 with a spacer 10. This embodiment differs from the work apparatus according to claim 11 only in the configuration of the spacer 10. The latter extends significantly further radially outward with respect to the rotational axis 7. The end piece 15 is held, preferably exchangeably, on the carrier 14 at the connecting section 59 (also see FIG. 4).

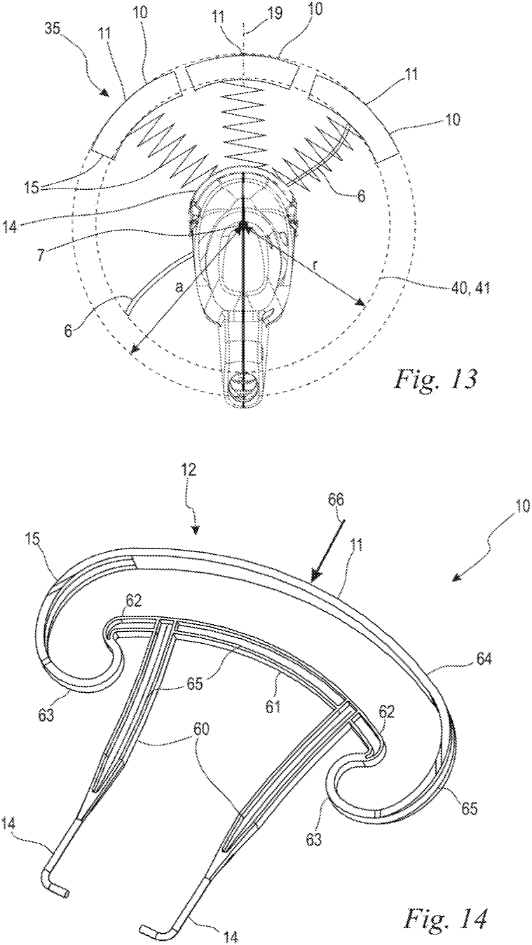

FIG. 13 shows a further embodiment according to the disclosure of the work apparatus 1, in which the end piece 15 of the spacer 10 has a contact element 57 and an elastically deformable spring element 58. The contact element 57 is held on the carrier 14 via the spring element 58. The contact element 57 therefore lies radially outside the spring element 58 with respect to the rotational axis 7. The contact region 11 which is provided for striking against possible obstacles is formed on the contact element 57. In the present embodiment, the contact element 57 is configured as a rigid element. However, it may also be expedient to likewise provide the contact element 57 as an elastically deformable element. However, the elastic main deformation into the second, deformed position 13 of the spacer is brought about by the spring element 58. As FIG. 12 shows, three spacers 10 are provided, wherein the carrier 14 of the spacers is formed integrally as a common carrier 14. A different number of spacers 10 may also be expedient.

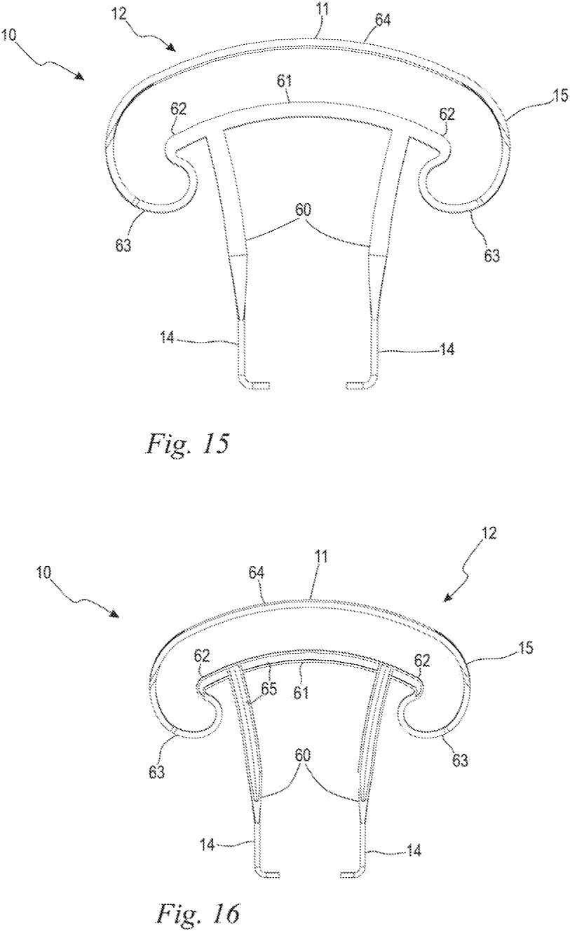

FIGS. 14 to 18 show a further embodiment according to the disclosure of the spacer 10. In this embodiment of the spacer 10, it is provided to fasten just this one spacer 10 to the front housing 35 of the work apparatus 1. With reference to the previous embodiments, the same reference signs correspond to the same components. In this embodiment, the spacer 10 includes two carriers 14 to which a single end piece 15 is fastened. The spacer 10 is to be fastened to the front housing 35 of the work apparatus 1 via the two carriers 14. The end piece 15 of the spacer 10 includes two extension arms 60 and the bracket 56. The bracket 56 is held on the carriers 14 via the extension arms 60. The extension arms 60 here form an extension of the carriers 14. The contact region 11 is formed on the bracket 56. The bracket 56 has a closed contour. The contact region 11 is formed on that side of the bracket 56 which faces away from the extension arms 60. The bracket 56 has a contour in the shape of a mushroom head. The end piece 15 forms a mushroom-shaped contour with the extension arms 60 and the bracket 56.

In the embodiment according to FIGS. 14 to 18, the spacer 10 is formed integrally. A single material which is an elastic material is preferably provided for the spacer 10. Consequently, the bracket 56 is also in the form of an elastic bracket. In an alternative configuration, it can also be provided that the spacer 10 is formed integrally, but the spacer 10 is formed from two materials or more. In such an embodiment, the carriers 14 are formed as rigidly as possible, accordingly a material which is rigid as possible is used for the carriers 14. By contrast, the bracket 56 is configured as an elastic element. The extension arms 60 can be both elastic and rigid.

As FIG. 14 shows, the bracket 56 includes a base section 61 into which the extension arms 60 lead. The extension arms 60 lead into the base section 61 adjacent to the outer ends 62 of the base section 61. A respective spring section 63 of the bracket 56 adjoins each of the outer ends 62 of the base section 61. The spring section 63 runs from the outer end 62 of the base section 61 in the direction of the extension arm 60 and subsequently extends away from the extension arm 60 in an arcuate manner. The two spring sections 63 are connected to each other via a contact section 64 of the bracket 56. The contact zone 11 of the spacer 10 is formed on the contact section 64. In the embodiment, the bracket 56 is symmetrical.

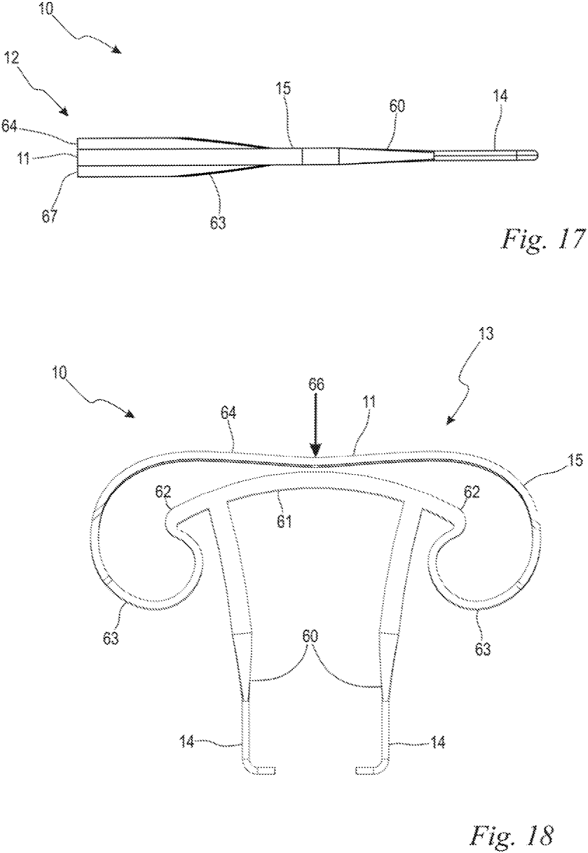

As in particular FIG. 14 shows, the bracket 56 has various cross sections in order therefore to adjust the degree of flexibility of the bracket 56 in a targeted way. For example, the cross section in the region of the spring section 63 is significantly reduced in comparison to the remaining sections 61, 64 of the bracket 56. In addition, the spring sections 63 have cutouts 65 in order to reduce the resistance moment in the direction of a force 66 acting orthogonally from the outside on the contact section. The cross section of the base section 61 is in turn configured in such a manner that the resistance moment in relation to such a force 66 is increased. In the contact section 64, the bracket 56 has a widening 67 in order to increase the contact area between bracket 56 and obstacle. As a result, the surface pressure upon contact between the bracket 56 and the obstacle is intended to be reduced so as to avoid damage to the obstacles (see FIG. 17). For the targeted adjustment of the degree of flexibility, the bracket 56 can be provided with different wall thicknesses, ribs, cutouts or comparable shapings on its sections 61, 63, 64 and on its extension arms 60.

FIGS. 14 to 17 show the spacer 10 in a non-deformed position 12, and FIG. 18 shows it in a deformed position 13.

It is understood that the foregoing description is that of the preferred embodiments of the invention and that various changes and modifications may be made thereto without departing from the spirit and scope of the invention as defined in the appended claims.

1. A portable work apparatus comprising:
a front housing;
an output shaft protruding from said front housing;
a main body connected to said output shaft;
a cutting tool arranged on said main body;
a drive motor;
said main body together with said cutting tool being drivable via said drive motor so as to rotate about a rotational axis of said output shaft;
said cutting tool defining a cutting circle with a cutting radius rotating in a cutting plane about said rotational axis;
a spacer arranged on said front housing and having a contact region;
said spacer being elastically deformable;
said contact region having a maximum distance, measured radially, to said rotational axis of said output shaft;
said maximum distance being greater than said cutting radius of said cutting tool in a first, non-deformed state of said spacer; and,
said spacer being elastically deformed in a second state such that said maximum distance is at most a same size as said cutting radius, and said spacer being arranged completely outside said cutting plane of said cutting tool.

2. The portable work apparatus of claim 1, wherein a maximum elastic deformation of said spacer corresponds to at least 5% of said maximum distance of said contact region from said rotational axis.

3. The portable work apparatus of claim 1, wherein said spacer includes a carrier and an end piece fastened to said carrier; and, said contact region of said spacer is formed on said end piece.

4. The portable work apparatus of claim 3, wherein said carrier is rigid and said end piece is elastically deformable.

5. The portable work apparatus of claim 3, wherein said carrier and said end piece are made of different materials.

6. The portable work apparatus of claim 3, wherein said end piece is made of an elastomer.

7. The portable work apparatus of claim 3, wherein said end piece is exchangeable on said carrier.

8. The portable work apparatus of claim 3, wherein said end piece is held on said carrier via a latching connection.

9. The portable work apparatus of claim 3, wherein said end piece is formed from a ring and an extension, said extension being arranged on said ring for fastening to said carrier.

10. The portable work apparatus of claim 8, wherein said ring has a wall thickness which decreases as a radial distance from said rotational axis of said output shaft increases.

11. The portable work apparatus of claim 1, wherein said spacer is one of a plurality of spacers provided on said front housing.

12. The portable work apparatus of claim 11, wherein said plurality of spacers are formed in a manner of fingers.

13. The portable work apparatus of claim 11, wherein said plurality of spacers extend in a longitudinal direction, each of said plurality of spacers being arranged radially with respect to said rotational axis of said output shaft.

14. The portable work apparatus of claim 3, wherein said end piece is configured as a bracket.

15. The portable work apparatus of claim 1, wherein said spacer is held pivotably on said front housing.

16. The portable work apparatus of claim 1 further comprising a receiving arrangement disposed on said front housing; and, said spacer being held releasably on said receiving arrangement.

17. The portable work apparatus of claim 3, wherein said end piece is held on the carrier at a connecting section; said connecting section is at a distance, as measured radially with respect to said rotational axis of said output shaft, from said rotational axis; and, said distance is at least 33% of said maximum distance of said contact region from said rotational axis.
